(19) United States
(12) Patent Application Publication
(10) Pub. No.: US 2023/0162047 A1
(43) Pub. Date: May 25, 2023

(54) Massively Scalable, Resilient, and Adaptive Federated Learning System

(71) Applicant: Huawei Technologies Co., Ltd., Shenzhen (CN)

(72) Inventors: Masood Seyed Mortazavi, Plano, TX (US); Hongwei Jin, Plano, TX (US); Ning Yan, Plano, TX (US)

(21) Appl. No.: 18/159,571

(22) Filed: Jan. 25, 2023

Related U.S. Application Data
(63) Continuation of application No. PCT/US2021/042762, filed on Jul. 22, 2021.
(60) Provisional application No. 63/057,512, filed on Jul. 28, 2020.
(60) Provisional application No. 63/071,582, filed on Aug. 28, 2020.

(51) Int. Cl. G06N 3/098

(52) U.S. Cl. CPC G06N 3/098

(57) ABSTRACT

A federated learning system is disclosed. The system includes scalable queues configured to receive model update contributions from a plurality of clients. The model update contributions contain updated model parameters. The system also includes a model repository configured to store a model for access by a plurality of clients and receive the model with updates based on the updated model parameters. The system also includes a configuration repository configured to store model polices including an update threshold indicating how many responses need to be received from the plurality of clients to initiate an update of the model. The system also includes hierarchical aggregators configured to update the model based on the updated model parameters from the plurality of clients and based on the update threshold.

### CROSS-REFERENCE TO RELATED APPLICATIONS

This patent application is a continuation of International Patent Application No. PCT/US2021/042762 filed on Jul. 22, 2021, by Futurewei Technologies, Inc., and titled “Massively Scalable, Resilient, and Adaptive Federated Learning System,” which claims the benefit of U.S. Provisional Patent Application No. 63/071,582, filed Aug. 28, 2020 by Futurewei Technologies, Inc., and titled “System, Mechanisms and Instrumentation for Massively Scalable, Resilient and Adaptive Federated Learning,” and U.S. Provisional Patent Application No. 63/057,512, filed Jul. 28, 2020 by Futurewei Technologies, Inc., and titled “System, Mechanisms and Instrumentation for Massively Scalable, Resilient and Adaptive Federated Learning,” which are hereby incorporated by reference.

### TECHNICAL FIELD

The present disclosure is generally related to machine learning, and is specifically related to a federated learning system that employs asynchronous contributions from an arbitrarily large number of clients that are not directly controlled by the system.

### BACKGROUND

Artificial Intelligence (AI), also known as machine learning, uses machine processes that simulate reasoning processes. For example, machine learning may employ a model of a problem that employs various parameters. A computing device may apply the model to various training data including input data corresponding to a known result. The device can then determine the extent various parameters correctly predicted the result based on the input data. The device can then update the model by emphasizing parameters that are predictive and de-emphasizing parameters that are less predictive, for example by applying weighting factors to the parameters. This process can be applied repeatedly (e.g., thousands of iterations) with various training data until the model converges at a consistent set of weighting factors for the parameters. Larger groups of potential parameters and larger variations in training data may result in a more accurate model. For example, parameters that appear predictive in some specific cases may not be predictive in more general cases, and hence should not be relied on. Diverse training data allows such false positives to be removed from the model. One concern with employing large groups of parameters is that training such models may require a large amount of computational resources. Further, obtaining diverse training data can become difficult for certain problems. For example, diverse training data describing user related activities may only be available with user permission due to privacy concerns.

### SUMMARY

In an embodiment, the disclosure includes a federated learning system comprising: scalable queues configured to receive model update contributions from a plurality of clients, the model update contributions containing updated model parameters; a model repository configured to store a model for access by the plurality of clients; a configuration repository configured to store model polices including an update threshold, the update threshold indicating how many responses need to be received from the plurality of clients to initiate an update of the model; and hierarchical aggregators configured to: generate a model update based on the updated model parameters received from the plurality of clients and based on the update threshold; and output the model update to the model repository.

Federated learning is an approach that employs multiple decentralized terminals to compute updates to a model. In a federated learning model, each terminal retains local training data and does not exchange the training data with the rest of the system. The terminal obtains the model, applies the local training data, and sends model updates to the federated learning system. In this way, the local training data is not shared and the privacy of the terminal owner can be maintained. As such, a federated learning system can employ participating user hardware resources and diverse real-world user data to train the model so long as user permission can be obtained.

The present embodiment includes a federated learning system configured to operate in conjunction with a wide variety of user terminals that are not under the direct control of the system. The federated learning system is asynchronous, and hence does not wait on any particular terminal or client operating thereon. The federated learning system updates the model based on model update contributions from the clients, but does so based on a response threshold or other mechanism. In this way, late responses do not stall the model update process. Further, the federated learning system tracks model sequence identifiers (IDs), and can therefore apply a staleness factor to reduce the effect of late responses on the system. For example, the federated learning system comprises a model repository that contains the current version of the model and a client configuration repository that contains a set of client configuration parameters related to a specific client or a group of clients. When the client begins a local model optimization cycle, the client obtains the current version of the model and the relevant client configuration parameters. The client then performs the local model optimization by using local private data to train the current version of the model based on the client configuration parameters. Accordingly, the federated learning system can use the client configuration parameters to control model related operations by the client. Once the local model optimization cycle is complete, the client sends a model update contribution to a set of scalable queues. The model update contribution contains parameter changes as well as model sequence ID so the system can determine staleness. The model update contribution can then be stored in a scalable queue until the federated learning system determines to update the model again. The model update contribution may be sorted into one of the scalable queues based on a hashing function. This approach allows the federated learning system to scale to allow for an arbitrary number of clients and allows for asynchronous operation.

The federated learning system further comprises a set of hierarchical aggregators and associated stream processors. The hierarchical aggregators perform an aggregation cycle to dequeue and aggregate model update contributions and the stream processors update the model based on the model update contributions. The updated model can then be stored in the model repository for asynchronous download by the clients. The federated learning system also comprises a participant monitoring repository and a policy engine. The hierarchical aggregators/stream processors can generate logs for the clients with data in the scalable queues and send such logs to the participant monitoring repository. The policy engine can then analyze the client logs from the participant monitoring repository asynchronously. Such analysis may be based on alerts, triggers, and/or queries. Based on the results of the analysis, the policy engine can make updates to the parameters in the client configuration repository. For example, the policy engine can alter or stop the local model optimization cycle at specific clients or for groups of clients, for example when a client is flagged as malicious, to support power efficiency, to reduce load on underperforming clients, to cause a model rollback, etc. Further, the federated learning system comprises an aggregation configuration repository that contains parameters used by the hierarchical aggregators/stream processors. The policy engine may also make changes to the aggregation configuration repository based on the logs, for example to change the frequency of the aggregation cycle. Further, the federated learning system can use security signatures in communications to protect against malicious interference. As such, the federated learning system as described operates asynchronously, allows for massive scalability, is resilient to client variations and inconsistencies, is secure, adapts to changes, and maintains user privacy (client specific data may not leave the terminal), while still taking advantage of user hardware and user data to update model parameters to improve the model.

Optionally, in any of the preceding aspects, another implementation of the aspect provides, wherein the configuration repository is further configured to store client configuration policies including client parameters affecting model operations at the plurality of clients.

Optionally, in any of the preceding aspects, another implementation of the aspect provides, wherein the client parameters direct model download operations and the model update contributions.

Optionally, in any of the preceding aspects, another implementation of the aspect provides, wherein the client parameters direct model analysis resume, model analysis stop, and model analysis exit.

Optionally, in any of the preceding aspects, another implementation of the aspect provides, wherein the client parameters direct local optimization at the plurality of clients.

Optionally, in any of the preceding aspects, another implementation of the aspect provides, wherein the model polices further include staleness policies.

Optionally, in any of the preceding aspects, another implementation of the aspect provides, further comprising a policy engine configured to set the model policies and the client configuration policies.

Optionally, in any of the preceding aspects, another implementation of the aspect provides, further comprising a participant monitoring repository configured to: receive monitoring logs indicating participant quality for the plurality of clients; and transmit the monitoring logs to the policy engine to support setting the model policies and the client configuration policies.

Optionally, in any of the preceding aspects, another implementation of the aspect provides, wherein the scalable queues receive model update contributions from the plurality of clients according to a hash function.

Optionally, in any of the preceding aspects, another implementation of the aspect provides, wherein the hierarchical aggregators are configured to dequeue and aggregate the model update contributions from the scalable queues.

Optionally, in any of the preceding aspects, another implementation of the aspect provides, wherein the policy engine is further configured to configure the hierarchical aggregators with hyper-parameters to scale aggregation weights.

Optionally, in any of the preceding aspects, another implementation of the aspect provides, wherein the hierarchical aggregators are configured to transmit monitoring logs to the participant monitoring repository.

In an embodiment, the disclosure includes a method of configuring a federated learning system, the method comprising: communicating, by a model repository, a model to a plurality of clients; receiving, by scalable queues, model update contributions from the plurality of clients, the model update contributions containing updated model parameters; and updating, by hierarchical aggregators, the model based on the updated model parameters from the plurality of clients and based on model polices including an update threshold indicating how many responses need to be received from the plurality of clients to initiate an update of the model.

Federated learning is an approach that employs multiple decentralized terminals to compute updates to a model. In a federated learning model, each terminal retains local training data and does not exchange the training data with the rest of the system. The terminal obtains the model, applies the local training data, and sends model updates to the federated learning system. In this way, the local training data is not shared and the privacy of the terminal owner can be maintained. As such, a federated learning system can employ participating user hardware resources and diverse real-world user data to train the model so long as user permission can be obtained.

The present embodiment includes a federated learning system configured to operate in conjunction with a wide variety of user terminals that are not under the direct control of the system. The federated learning system is asynchronous, and hence does not wait on any particular terminal or client operating thereon. The federated learning system updates the model based on model update contributions from the clients, but does so based on a response threshold or other mechanism. In this way, late responses do not stall the model update process. Further, the federated learning system tracks model sequence IDs, and can therefore apply a staleness factor to reduce the effect of late responses on the system. For example, the federated learning system comprises a model repository that contains the current version of the model and a client configuration repository that contains a set of client configuration parameters related to a specific client or a group of clients. When the client begins a local model optimization cycle, the client obtains the current version of the model and the relevant client configuration parameters. The client then performs the local model optimization by using local private data to train the current version of the model based on the client configuration parameters. Accordingly, the federated learning system can use the client configuration parameters to control model related operations by the client. Once the local model optimization cycle is complete, the client sends a model update contribution to a set of scalable queues. The model update contribution contains parameter changes as well as model sequence ID so the system can determine staleness. The model update contribution can then be stored in a scalable queue until the federated learning system determines to update the model again. The model update contribution may be sorted into one of the scalable queues based on a hashing function. This approach allows the federated learning system to scale to allow for an arbitrary number of clients and allows for asynchronous operation.

The federated learning system further comprises a set of hierarchical aggregators and associated stream processors. The hierarchical aggregators perform an aggregation cycle to dequeue and aggregate model update contributions and the stream processors update the model based on the model update contributions. The updated model can then be stored in the model repository for asynchronous download by the clients. The federated learning system also comprises a participant monitoring repository and a policy engine. The hierarchical aggregators/stream processors can generate logs for the clients with data in the scalable queues and send such logs to the participant monitoring repository. The policy engine can then analyze the client logs from the participant monitoring repository asynchronously. Such analysis may be based on alerts, triggers, and/or queries. Based on the results of the analysis, the policy engine can make updates to the parameters in the client configuration repository. For example, the policy engine can alter or stop the local model optimization cycle at specific clients or for groups of clients, for example when a client is flagged as malicious, to support power efficiency, to reduce load on underperforming clients, to cause a model rollback, etc. Further, the federated learning system comprises an aggregation configuration repository that contains parameters used by the hierarchical aggregators/stream processors. The policy engine may also make changes to the aggregation configuration repository based on the logs, for example to change the frequency of the aggregation cycle. Further, the federated learning system can use security signatures in communications to protect against malicious interference. As such, the federated learning system as described operates asynchronously, allows for massive scalability, is resilient to client variations and inconsistencies, is secure, adapts to changes, and maintains user privacy (client specific data may not leave the terminal), while still taking advantage of user hardware and user data to update model parameters to improve the model.

Optionally, in any of the preceding aspects, another implementation of the aspect provides, wherein communicating the model includes communicating to the plurality of clients model parameters, a model sequence identifier for a version of the model, a system signature, or combinations thereof.

Optionally, in any of the preceding aspects, another implementation of the aspect provides, wherein the model update contributions include a model sequence identifier for a version of the model associated with the updated model parameters, training factors used by the corresponding client, a client identifier associated with the corresponding client, a participant signature, or combinations thereof.

Optionally, in any of the preceding aspects, another implementation of the aspect provides, further comprising transmitting, by the hierarchical aggregators, a monitoring log indicating participant quality to a participant monitoring repository.

Optionally, in any of the preceding aspects, another implementation of the aspect provides, wherein the monitoring log includes a counter, a client identifier, include a model sequence identifier, client staleness data, client speed data, client throughput data, or combinations thereof.

Optionally, in any of the preceding aspects, another implementation of the aspect provides, further comprising transmitting, by a policy engine, aggregation configuration of the hierarchical aggregators to a configuration repository.

Optionally, in any of the preceding aspects, another implementation of the aspect provides, wherein the aggregation configuration includes aggregation hyper-parameters including window sizes, discount rates, or combinations thereof.

Optionally, in any of the preceding aspects, another implementation of the aspect provides, further comprising transmitting, by a policy engine, client configuration policies to a configuration repository.

Optionally, in any of the preceding aspects, another implementation of the aspect provides, wherein the client configuration policies include parameters affecting model operations at the plurality of clients including a model download policy, a model contribution policy, a resume command, a stop command, an exit command, a system signature, or combinations thereof.

In an embodiment, the disclosure includes a federated learning system comprising: a transmitting means for transmitting a model to a plurality of clients; a receiving means for receiving model update contributions from the plurality of clients, the model update contributions containing updated model parameters; and an updating means for updating the model based on the updated model parameters from the plurality of clients and based on model polices including an update threshold indicating how many responses need to be received from the plurality of clients to initiate an update of the model.

Federated learning is an approach that employs multiple decentralized terminals to compute updates to a model. In a federated learning model, each terminal retains local training data and does not exchange the training data with the rest of the system. The terminal obtains the model, applies the local training data, and sends model updates to the federated learning system. In this way, the local training data is not shared and the privacy of the terminal owner can be maintained. As such, a federated learning system can employ participating user hardware resources and diverse real-world user data to train the model so long as user permission can be obtained.

The present embodiment includes a federated learning system configured to operate in conjunction with a wide variety of user terminals that are not under the direct control of the system. The federated learning system is asynchronous, and hence does not wait on any particular terminal or client operating thereon. The federated learning system updates the model based on model update contributions from the clients, but does so based on a response threshold or other mechanism. In this way, late responses do not stall the model update process. Further, the federated learning system tracks model sequence identifiers (IDs), and can therefore apply a staleness factor to reduce the effect of late responses on the system. For example, the federated learning system comprises a model repository that contains the current version of the model and a client configuration repository that contains a set of client configuration parameters related to a specific client or a group of clients. When the client begins a local model optimization cycle, the client obtains the current version of the model and the relevant client configuration parameters. The client then performs the local model optimization by using local private data to train the current version of the model based on the client configuration parameters. Accordingly, the federated learning system can use the client configuration parameters to control model related operations by the client. Once the local model optimization cycle is complete, the client sends a model update contribution to a set of scalable queues. The model update contribution contains parameter changes as well as model sequence ID so the system can determine staleness. The model update contribution can then be stored in a scalable queue until the federated learning system determines to update the model again. The model update contribution may be sorted into one of the scalable queues based on a hashing function. This approach allows the federated learning system to scale to allow for an arbitrary number of clients and allows for asynchronous operation.

The federated learning system further comprises a set of hierarchical aggregators and associated stream processors. The hierarchical aggregators perform an aggregation cycle to dequeue and aggregate model update contributions and the stream processors update the model based on the model update contributions. The updated model can then be stored in the model repository for asynchronous download by the clients. The federated learning system also comprises a participant monitoring repository and a policy engine. The hierarchical aggregators/stream processors can generate logs for the clients with data in the scalable queues and send such logs to the participant monitoring repository. The policy engine can then analyze the client logs from the participant monitoring repository asynchronously. Such analysis may be based on alerts, triggers, and/or queries. Based on the results of the analysis, the policy engine can make updates to the parameters in the client configuration repository. For example, the policy engine can alter or stop the local model optimization cycle at specific clients or for groups of clients, for example when a client is flagged as malicious, to support power efficiency, to reduce load on underperforming clients, to cause a model rollback, etc. Further, the federated learning system comprises an aggregation configuration repository that contains parameters used by the hierarchical aggregators/stream processors. The policy engine may also make changes to the aggregation configuration repository based on the logs, for example to change the frequency of the aggregation cycle. Further, the federated learning system can use security signatures in communications to protect against malicious interference. As such, the federated learning system as described operates asynchronously, allows for massive scalability, is resilient to client variations and inconsistencies, is secure, adapts to changes, and maintains user privacy (client specific data may not leave the terminal), while still taking advantage of user hardware and user data to update model parameters to improve the model.

Optionally, in any of the preceding aspects, another implementation of the aspect provides, the system being further configured to perform any combination of the elements of any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a federated learning system.

FIG. 2 is a schematic diagram of a terminal configured to send model update contributions to a federated learning system.

FIG. 3 is a protocol diagram of a method of recruiting a terminal to participate in a federated learning system.

FIG. 4 is a protocol diagram of a method of obtaining a model update contribution from a terminal in a federated learning system.

FIG. 5 is a protocol diagram of a method of performing an aggregation cycle to update a model in a federated learning system based on asynchronous model update contributions from a group of clients that are uncontrolled by the system.

FIG. 6 illustrates example federated learning messages that can be employed to operate a federated learning system.

FIG. 7 is a schematic diagram of an example federated learning device for use in a federated learning system.

FIG. 8 is a flowchart of an example method of operating a federated learning system.

FIG. 9 is a schematic diagram of another example federated learning device for use in a federated learning system.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Federated learning is an approach that employs multiple decentralized terminals to compute updates to a model. In a federated learning model, each terminal retains local training data and does not exchange the training data with the rest of the system. The terminal obtains the model, applies the local training data, and sends model updates to the federated learning system. In this way, the local training data is not shared and the privacy of the terminal owner can be maintained. As such, a federated learning system can employ participating user hardware resources and diverse real-world user data to train the model so long as user permission can be obtained. The federated learning model is promising, but faces certain challenges.

For example, a federated learning system should harvest large statistical training signals/data sets based on user data while keeping such user data private. Further, the federated learning system should be capable of managing a very large number of user participants. The federated learning system should also be capable of dealing with variations in user terminal hardware and service, such as variations in connectivity, battery life, system compute capability/speed, system latencies, hardware age, service providers, service subscriptions, security, etc. The federated learning system should also be capable of dealing with clients leaving and joining recruitment at different points during the federated learning processes. The federated learning system should also be capable of ensuring computation of statistically valid results, while allowing for variations such as changes in participation, variations in staleness rates, and other variations in update contributions. The federated learning system should also be capable of operating at a massive scale. The federated learning system should also mitigate tampering with the learning process by malicious users.

Disclosed herein is a federated learning system configured to operate in conjunction with a wide variety of user terminals that are not under the direct control of the system. The federated learning system is asynchronous, and hence does not wait on any particular terminal or client operating thereon. The federated learning system updates the model based on model update contributions from the clients, but does so based on a response threshold or other mechanism. In this way, late responses do not stall the model update process. Further, the federated learning system tracks model sequence identifiers (IDs), and can therefore apply a staleness factor to reduce the effect of late responses on the system.

For example, the federated learning system comprises a model repository that contains the current version of the model and a client configuration repository that contains a set of client configuration parameters related to a specific client or a group of clients. When the client begins a local model optimization cycle, the client obtains the current version of the model and the relevant client configuration parameters. The client then performs the local model optimization by using local private data to train the current version of the model based on the client configuration parameters. Accordingly, the federated learning system can use the client configuration parameters to control model related operations by the client. Once the local model optimization cycle is complete, the client sends a model update contribution to a set of scalable queues. The model update contribution contains parameter changes as well as model sequence identifier (ID) so the system can determine staleness. The model update contribution can then be stored in a scalable queue until the federated learning system determines to update the model again. The model update contribution may be sorted into one of the scalable queues based on a hashing function. This approach allows the federated learning system to scale to allow for an arbitrary number of clients and allows for asynchronous operation.

The federated learning system further comprises a set of hierarchical aggregators and associated stream processors. The hierarchical aggregators perform an aggregation cycle to dequeue and aggregate model update contributions and the stream processors update the model based on the model update contributions. The updated model can then be stored in the model repository for asynchronous download by the clients. The federated learning system also comprises a participant monitoring repository and a policy engine. The hierarchical aggregators/stream processors can generate logs for the clients with data in the scalable queues and send such logs to the participant monitoring repository. The policy engine can then analyze the client logs from the participant monitoring repository asynchronously. Such analysis may be based on alerts, triggers, and/or queries. Based on the results of the analysis, the policy engine can make updates to the parameters in the client configuration repository. For example, the policy engine can alter or stop the local model optimization cycle at specific clients or for groups of clients, for example when a client is flagged as malicious, to support power efficiency, to reduce load on underperforming clients, to cause a model rollback, etc. Further, the federated learning system comprises an aggregation configuration repository that contains parameters used by the hierarchical aggregators/stream processors. The policy engine may also make changes to the aggregation configuration repository based on the logs, for example to change the frequency of the aggregation cycle. Further, the federated learning system can use security signatures in communications to protect against malicious interference. As such, the federated learning system as described operates asynchronously, allows for massive scalability, is resilient to client variations and inconsistencies, is secure, adapts to changes, and maintains user privacy (client specific data may not leave the terminal), while still taking advantage of user hardware and user data to update model parameters to improve the model.

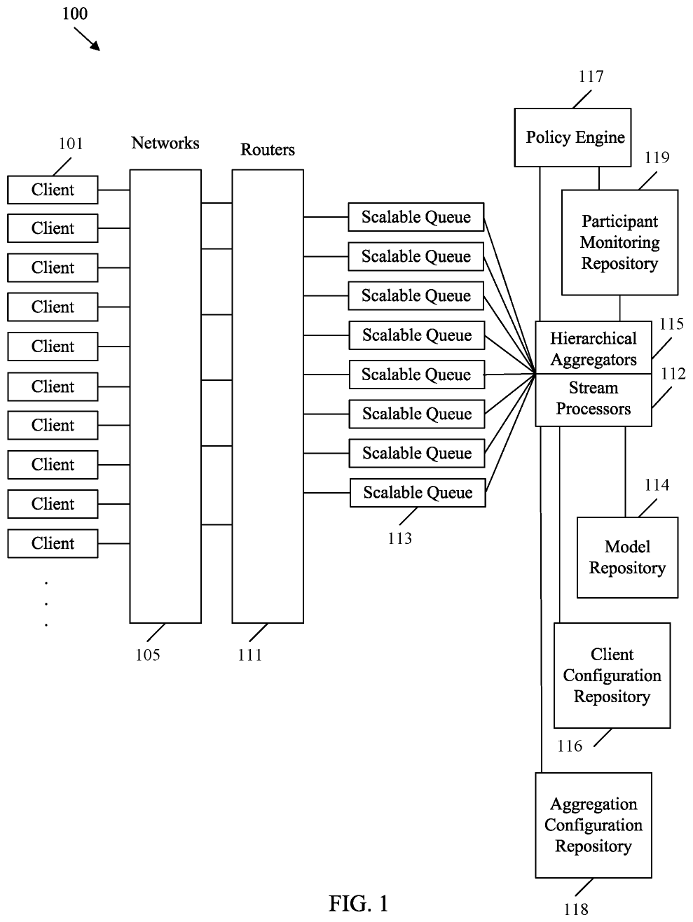

FIG. 1 is a schematic diagram of a federated learning system 100. The federated learning system 100 is configured to use clients 101 to update a model according to a machine learning process. Each client 101 includes a user terminal that further includes a software application configured to operate on a user terminal. The user terminal may be any computing device capable of connecting to one or more networks shown generically as network 105. Network 105 may comprise a single network, or multiple networks of the same or of different types. A client 101 may comprise a cell phone, smartphone, tablet, personal computer, laptop computer, or other user device. A client 101 is configured to access user data stored on the terminal and use such user data to train a model. For example, a client 101 can download a current model including model parameters and client configuration parameters. The client 101 employs the user data as training data and applies the training data to the current version of the model based on the client configuration parameters as part of a local model optimization cycle. The client 101 can then upload suggested changes to model parameters as part of a model update contribution. The client 101 may also upload cycle configuration data that describes the performance of the local model optimization cycle on the client 101 for use in managing the system. The client 101, in order to preserve user privacy, may not, however, upload the user data.

As shown, the federated learning system 100 may access an arbitrarily large group of clients 101. Accordingly, the clients 101 may each download the model and client configuration parameters, perform local model optimization cycle, and submit model update contributions asynchronously. For example, a client 101 may perform a local model optimization cycle at certain times based on user settings. As another example, a client 101 may enter and/or leave the federated learning process whenever the user desires. In yet another example, a client 101 may have a sporadic connection to one of the networks 105, and may only perform local model optimization cycles as the connection allows. Further, a client 101 may be limited in the speed of the local model optimization cycle by the hardware of the terminal that operates the client 101. Accordingly, different clients 101 may perform local model optimization cycles on different versions of the model, depending on the version available for download at the start of the local model optimization cycle and the length of time the client 101 uses to complete the cycle and submit model update contributions. The clients 101 each submit a model sequence ID as part of the model update contribution in order to allow the federated learning system 100 to determine staleness. Staleness describes the scenario where a client 101 performs a local model optimization cycle using an old version of the model.

The federated learning system 100 may discount stale model update contributions depending on a level of staleness. For example, the value of the discount may increase as the separation between the client's 101 model version and the current model version increases. The clients 101 may also submit a participant signature with the model update contribution to allow the federated learning system 100 to determine that only verified clients 101 are submitting model update contributions. This allows the system to flag and disregard fake/malicious model update contributions.

The client 101 downloads the model/model parameters and client parameters and uploads model update contributions and cycle configuration data via networks 105. A network 105 is any communication system configured to transfer data from a user terminal to a data center, such as a wireless network (e.g., a cellular network, an Institute of Electrical and Electronics Engineers (IEEE) 802.11 (WIFI) network, a satellite network, etc.), an electrical communication network, an optical communication network, or combinations thereof. The networks 105 may vary widely depending on the capabilities of the clients 101.

Regardless of the topology of the various networks that comprise network 105, the model update contributions and cycle configuration data are received by routers 111 at a datacenter. A router 111 is any device capable of forwarding network traffic based on predetermined rules. For example, the routers 111 may forward model update contributions and cycle configuration data to scalable queues 113 based on hashing rules. As a specific example, the routers 111 may compute a hash based on mobile terminal and/or participant ID. The routers 111 may employ any randomization scheme designed to provide global statistical regularization. It should be noted that the hashing scheme may be changed at any time.

The scalable queues 113 are storage entities at a data center that can adaptively increase in size and/or number based on the volume of model update contributions received from the clients 101. The scalable queues 113 are scalable (e.g., horizontally) and messages are logically partitioned among these queues based on message, terminal, and/or client ID. These logical partitions may depend on the hash of the ID. In an example, when more queues are needed for horizontal scaling, the hash partition is recomputed and hash-partition tables are updated for further routing. Maps of the scalable queues 113 can be managed by a configuration management system. Accordingly, as more clients 101 are added to the federated learning system 100, the scalable queues 113 increase in storage capability to support the corresponding model update contributions. The scalable queues 113 can store the model update contributions from the clients 101 in a first in, first out storage structure. In this way, the model update contributions can be received when a client 101 completes a local model optimization cycle and stored until the system determines to update the model. As such, the scalable queues 113 are configured to receive model update contributions containing updated model parameters from the clients 101. It should be noted that various software components can be utilized to perform runtime configuration management of queues and manage failure recovery for the scalable queues 113.

The federated learning system 100 also comprises hierarchical aggregators 115 and stream processors 112 at the data center that collectively perform an aggregation cycle to update the model. The hierarchical aggregators 115 are a group of processing components configured to dequeue data from the scalable queues 113 and arrange such data into a data stream of model update contributions. The hierarchical aggregators 115 are arranged in a hierarchy to allow the aggregation system to dynamically expand as the number of clients 101 increase. The stream processors 112 are a group of processing components that read the data stream output from the hierarchical aggregators 115 and use the data stream of model update contributions to update the model. Specifically, the hierarchical aggregators 115 and stream processors 112 use machine learning principals to incrementally update the model (e.g., generate model updates) based on a large number of model update contributions from a large number of clients 101. Specifically, the hierarchical aggregators 115 and stream processors 112 only change model parameters when a statistically significant number of model update contributions indicate that such a change is likely to improve the predictive capability of the model. The hierarchical aggregators 115 and stream processors 112 employ various repositories to operate asynchronously from the clients 101. For example, the hierarchical aggregators 115 and/or stream processors 112 may update the model based on updated model parameters from the clients 101 based on an update threshold that indicates a number of received model update contributions. The hierarchical aggregators 115 and stream processors 112 may use federated learning model parameter aggregation algorithms to compute each subsequent model as discussed below.

The federated learning system 100 also comprises a model repository 114, a client configuration repository 116, an aggregation configuration repository 118, and a participant monitoring repository 119 in the data center. The model repository 114 stores the current version of the model as well as previous versions of the model to support analysis of stale model update contributions and rollback functionality. For example, the clients 101 may download the current version of the model and/or associated model parameters from the model repository 114 at the start of a local optimization cycle. The model repository 114 may send a system signature to the clients 101 along with the model and/or associated model parameters to provide authentication-based security for the communication. Further, the hierarchical aggregators 115 and/or stream processors 112 may obtain various versions of the model from the model repository 114 as part of the aggregation cycle. The hierarchical aggregators 115 and/or stream processors 112 can then compute an updated model based on the model update contributions and store the updated model back in the model repository 114. In this way, the model can be viewed, analyzed, and/or updated asynchronously by both the clients 101 and the hierarchical aggregators 115 and stream processors 112. Each component can operate based on the current version of the model stored in the model repository 114 at the time of access. As such, the model repository 114 is configured to store the model for access by the clients and receive model updates from the hierarchical aggregators 115 and/or stream processors 112 based on the updated model parameters.

The client configuration repository 116 stores client configuration policies including client parameters affecting model operations at the clients 101. The client parameters may direct the operation of the local model optimization cycle at specific clients 101, groups of clients 101, and/or all clients 101. For example, the client parameters may be set based on a policy engine 117. The client parameters may direct model download operations and/or model update contributions at the clients 101. For example, the client parameters may provide client 101 specific instructions indicating when and where to download the model from the model repository 114, indicate how often the client 101 should start a local model optimization cycle (e.g., to support energy and/or resource usage optimization), indicate an allowable frequency of model update contributions (e.g., to prevent distributed denial of service attacks), etc. As a general example, the client parameters may indicate that the client 101 should only perform a local model optimization cycle when the user is not actively using another process in the foreground, when the terminal is charging/over a certain charge threshold, etc. Further, the client parameters may direct model analysis resume, model analysis stop, and model analysis exit.

As an example, the client configuration repository 116 can receive parameters to have malicious clients 101 stop operations according to a model analysis exit command. As another example, the client configuration repository 116 can receive parameters to cause clients 101 to stop model analysis prior to a model version rollback and resume activity after the rollback is complete according to the model analysis stop command and the model analysis resume commands, respectively. As such, the client parameters in the client configuration repository 116 direct the local optimization process at the clients 101.

The aggregation configuration repository 118 stores model policies from the policy engine 117. Such policies are read by the hierarchical aggregators 115 and/or stream processors 112 prior to performing an aggregation cycle. The model policies control when and how the hierarchical aggregators 115 and/or stream processors 112 perform model updates based on model update contributions. For example, the model policies in the aggregation configuration repository 118 can include an update threshold indicating an amount of received responses from the clients 101 to initiate an update of the model (e.g., a percentage of responses versus the number of clients 101, a statistically significant number of responses, etc.) As such, the model policies can control the circumstances that trigger an aggregation cycle. Further, the model policies can include staleness policies that direct the deemphasis of received model update contributions when such contributions relate to older versions of the model. In addition, the model policies may include hyper-parameters that scale aggregation weights used by the hierarchical aggregators 115. Accordingly, the model policies in the aggregation configuration repository 118 direct the aggregation cycle for model updates.

The participant monitoring repository 119 is configured to receive monitoring logs indicating participant quality for the clients 101. For example, the hierarchical aggregators 115 and/or stream processors 112 can receive cycle configuration data that describes the performance of the local model optimization cycle on corresponding clients 101 as part of the model update contributions in the scalable queues 113. The hierarchical aggregators 115 and/or stream processors 112 can create monitoring logs based on the cycle configuration data and send the monitoring logs to the participant monitoring repository 119. The participant monitoring repository 119 can then transmit the monitoring logs to the policy engine 117 upon request to support setting the model policies and the client configuration policies. For example, the monitoring logs may indicate clients 101 exhibiting suspicious behavior, clients 101 that consistently provide stale updates, etc.

The federated learning system 100 also comprises a policy engine 117 configured to set the model policies at the aggregation configuration repository 118 and the client configuration policies at the client configuration repository 116. The policy engine 117 is a software process operating in a datacenter. The policy engine 117 may read and analyze monitoring logs from the participant monitoring repository 119. For example, the policy engine 117 can be configured with alerts and/or triggers. Once triggered, the policy engine 117 can execute queries on the monitoring logs and generate configuration changes. In this way, the policy engine 117 can dynamically alter the operation of the federated learning system 100 based on operating conditions.

As a specific example, the policy engine 117 can determine that particular clients 101 or classes of clients 101 are underperforming (e.g., sending stale data) and can set client configuration policies to address issues, for example by altering the local optimization cycle at such clients 101. As another example, the policy engine 117 can alter client configuration policies to remove particular clients 101 from the system and/or cause clients 101 to stop/resume activity (e.g., to support rollbacks). Further, the policy engine 117 can alter staleness policies and change how staleness is handled by the hierarchical aggregators 115 and/or stream processors 112. In addition, the policy engine 117 can alter hyperparameters to alter how the hierarchical aggregators 115 and/or stream processors 112 perform aggregation cycles. As such, the policy engine 117 can control the operation of the entire federated learning system 100 by reacting to the participant monitoring repository 119 and altering the client configuration repository 116 and the aggregation configuration repository 118.

Accordingly, the federated learning system 100 provides an asynchronous queue-based mechanism for communicating optimization/gradient contributions in a machine learning context. Participating clients 101 send their model update contributions to a system of scalable queues 113. The model update contributions may include parameter updates, signature, model sequence numbers, and/or other participant configuration data. Some select clients 101 may therefore participate as model testers. The hierarchical aggregators 115 and/or stream processors 112 in the data center can dequeue and aggregate the model update contributions using an aggregation algorithm that accounts for staleness of statistical models used to produce update contributions.

The hierarchical aggregators 115 and/or stream processors 112 use various filters to decide which contributions to take and may send stop/resume messages to clients 101. The hierarchical aggregators 115 may also adaptively set some system parameters in the repositories, such as staleness window size, number of contributions to aggregate before a new model is produced, etc. The updated model can be staged and addressed according to a universal resource locator (URL), which is published to clients 101. The model/model version may be downloaded by the clients 101 and may include parameters, signature, model sequence number, and other aggregation service configuration data. Clients 101 may check the model repository 114 at the known URL for any recent update before attempting a local optimization cycle. Once a client 101 finishes an internal optimization cycle, the client 101 produces and send a model update contribution to the scalable queues 113.

As an example, a client 101 may send computed model parameters to a server containing the scalable queues 113 in a data center in a model update contribution. The model update contribution and a cycle configuration can be sent via a put model, such as a hypertext transfer protocol (HTTP) put/post request. There may be hundreds of thousands to millions of clients 101 transmitting model update contributions, for example via a mobile network, such as networks 105. The routers 111 may act as load balanced HTTP request routers, and may forward the model update contributions to the scalable queues 113 for user by the hierarchical aggregators 115.

As another example, federated learning system 100 can be set up to support a model refresh of a globally aggregated model. For example, a HTTP get request can be used to get the model and the client configuration. The client configuration can be obtained from the client configuration repository 116 and the model can be obtained from the model repository 114. The data can be forwarded to the routers 111, which can act as load balanced HTTP request routers for forwarding the data toward each client 101 via the networks 105.

Handling of model versions and model rollback is now discussed. Aggregated model versions can kept by the server, such as in the model repository 114. The clients 101, which run the local optimization, should maintain one version of the model. This version should be the last version downloaded by the client 101. When a server, such as the policy engine 117, decides to roll-back all of the clients 101, the server can perform a rollback as follows. The client configurations in the client configuration repository 116 can all be set to pause (and/or a pause message may be sent). The next model to be downloaded can be set to the target rolled-back model. The rolled-back model can be set to the next sequence number for download and/or further skips forward in sequence number can be added to cause gradual flush of all earlier-produced updates which become too stale due to the difference in model sequence numbers. All the client configurations can be set to resume (and/or resume messages may be sent). In some implementations, the model sequence ID may always increase, but an older model can be revived with a new sequence ID. Further skips forward in sequence ID further speed the flushing of contributions in scalable queues 113 as such contributions are determined to be too stale.

Clusters of queues and aggregation hierarchy are now discussed. The hierarchical aggregators 115/stream processers 112 are responsible for dequeuing contributions, aggregating them, and producing monitoring/logging data related to the model update contributions. Since there is a cluster of scalable queues 113, a cluster of aggregator hubs may be used to dequeue the contributions that arrive as there may be millions of participants enqueuing their contributed model updates. The hierarchy for the hierarchical aggregators 115 is stipulated in order to aggregate results from all aggregators that are dequeuing contributions. The hierarchy could be a singleton if a singleton process can handle aggregation of all contributions arriving on all scalable queues 113. This is unlikely in large systems involving, potentially, millions of users. At the same time, a deep hierarchy is unlikely to be needed. In general, a two-level hierarchy may be sufficient. This depends on the volume of contributions in the scalable queues 113. However, the disclosed design can work with shallow or deep hierarchies as desired.

A cluster of scalable queues 113 can also be a singleton, but a singleton queue may be unable to handle many clients 101. To go to hundreds of thousands and millions of clients, a router 111 and a scalable queue 113 cluster may be needed. The routers 111 may employ a hash function (or a mapping table) that maps each client 101 to a corresponding scalable queue 113. This hash function and mapping table from clients 101 to their respective scalable queues 113 can be managed by a configuration system.

An example client configuration definition, as stored in the client configuration repository 116, is now provided. A client configuration may be made per client 101 and/or may be global to all clients 101 in some cases. The client configuration may include a batch size per optimization cycle, a number of internal batches to be processed per optimization cycle, a number of epochs (repeated use of batches) allowed in a corresponding local optimization cycle, an indication of whether to pause, resume, and/or stop participation, and/or an indication of whether to skip training some sequence IDs.

An example aggregation configuration, as stored in the aggregation configuration repository 118, is now provided. The example aggregation configuration can include a number of distinct participant contributions to aggregate in an aggregation hierarchy for each layer of the hierarchy, a staleness window size to indicate acceptable staleness of the model used by a participant, and/or a series of hyper-parameters to scale aggregation weights, which take into account staleness, number of data elements used in the local training, and number of local epochs.

Updating configurations in order to produce adaptivity is now discussed. The participant monitoring repository 119 and the policy engine 117 may update configurations adaptively. This allows the whole system to produce robust behavior for statistical convergence. Servers and participants can obtain updated configurations and behave accordingly. For example, when a client 101 is too slow (e.g., indicated by infrequent valid contributions), the corresponding client configuration can be changed to reduce batch size, reduce number of internal batches, and/or reduce the number of internal epochs. As another example, when a participant misses a staleness window and makes unusable contributions too often, the client configuration can be changed to stop the participant from participating and/or a stop message may be sent to the participant. As another example, when a large number of participants miss on staleness, corresponding configurations can be changed to slow the rate of model generation (e.g. by aggregating a larger number of enqueued contributions in each aggregation cycle to produce a new model) and/or the slowest selected percentage of participants may be stopped and faster participants recruited.

In another example, a trade-off of global compute load against test accuracy can be made. The hierarchical aggregators 115 and stream processors 112 processing the model update contributions from the scalable queues 113 can update the system monitoring's logs of the global compute load. This training compute load at the clients could be provided by clients in their model update messages or through a compute load estimation by the server system based on requested computation (e.g., based on the number of batches and epochs of training used at the clients 101, the type of accelerator used at the client 101, and/or the type machine learning platform used on the client 101). These estimations of giga floating point operations (GFLOPS) used in each client 101, along with operating graphs, which can provide accuracy-GFLOPs tradeoffs, can be used to vary the operating envelop. Varying the operating envelop allows for the usage of the minimal amount of GFLOPs and/or energy to achieve acceptable error reductions profiles. For example, at the start of the process moderate values of participation and refresh rates can be used. Later, participation rates can be reduced to reduce GFLOPS and energy use, while maintaining high values of refresh in order to achieve accurate results comparable to a base line of high participation and high refresh, which induces high GFLOPS and energy utilization overall.

A common public key cryptography can be used to mitigate occurrences of data intruders. The system can be made secure in order to ensure trustable model contributions (produced by client apps) and global model refreshes (produced by the aggregation system). The system signs packages picked up by the client applications. The packages contain updated global models. The packages also contain client configurations. The client application instances running on the terminal sign packages picked up (by dequeuing) by the server system as part of model update contributions. Messages inside the data-center may be fully secure from man-in-the-middle-attacks.

Aggregation algorithms are also discussed. Algorithm 1 provides an example of semi-synchronous case. In this algorithm, clients 101 (with probability p) can be allowed to participate in each aggregation round, but all clients 101 are expected to have refreshed themselves to the most recent model prior to every local optimization cycle. Algorithm 1, denoted as FedAvg, may not be communication efficient with respect to the global model as all clients 101 have to participate and all clients 101 have to refresh. When p=1, all clients 101 are expected to participate. This can be implemented within the federated learning system 100 by relaxing both refresh and participation requirements to result in a fully asynchronous adaptive system.

Algorithm 1: FedAvg

```
Sever executes:
For each round s=0,... do
  Cₛ ← (random select K clients)
  For each client c ∈ Cₛ do
    wₛ₊₁^{(c)}← ClientUpdate (c, wₛ); // weighted average
End
ClientUpdate (c, w):
for local step j=1,..., J do
  w ← w−η ∇ F (w; z) for z ~ P_{c}
end
return w to server
```

where c is a client, Cₛ is the group of all clients, K is the number of clients, w is a set of model weights, wₛ is a current set of model weights, wₛ₊₁^{(c)} is an updated set model weights from a client, j is an optimization step in the set of all optimization steps 1 through J at a client, z is a random variable representing client data, P_{c} is the distribution of data specific to client c, from which z is drawn, and w−η∇F (w; z) is the update expression for model weights using gradient decent, where F is the “loss” function, often referred to as minimization objective, ∇ is gradient with respect to the weights and η is the learning rate.

An example aggregation algorithm for fully asynchronous adaptive federated learning is discussed. Algorithm 2 may be denoted as Simulating Asynchronous FedAvg Aggregation Algorithm with Adaptative Learning and can be implemented as follows:

Algorithm 2:

| Server executes: | //initiate sequence numbers |
|---|---|
| S[c]: = 0 for c ∈ C; | |
| S = 0; | //current sequence number |
| M = { } | // saved models |
| For each round s=0, . . . do | //save current model |
| M[s] = wₛ; | |
| if \|M\| > ω then | |
| drop staled model M | |
| end | |
| Cₛ ← (random select P clients based on pₛ) | |
| For each client c ∈ Cs do | |
| if s − S[c] > ω then | |
| continue; | //ignore client c |
| end | |
| wₛ₊₁^{(c)} ← ClientUpdate (c, ws) | |
| end | |
| /* adaptive update with staleness | */ |
| ${w}_{s + 1} ← {w}_{s} + {γ}_{s} {w}_{s + 1} {\sum }_{c ∈ C} \frac{{n}_{c}}{{n}_{{C}_{s}}} {σ}_{s}^{( c )} {w}_{s}^{( c )}$ | |
| Q_{S} ← (random select Q clients based on qₛ) | |
| For each client c ∈ Qₛ do | |
| S[c] ← s+1; | //refresh sequence numbers |

end
end

where S[c] is a set of sequence numbers for a client c, C is the group of all clients, M is a set of models, M[s] is a saved model with a current set of model parameters wₛ, γₛ, pₛ, qₛ represent the adaptive federated learning with aggregation rate, participate rate, and refresh rate. σₛ^{c} represents the discounted staleness. ω is the staleness window including all models on which basis local optimizations are accepted by the aggregators. w represents model weights. n_{c} represents batch number used by client. n_{C}_{ₛ} represents batch numbers used by all clients Cs. s represents model sequence number. Given that contributions are enqueued and dequeued asynchronously and adaptively for aggregation purposes, Algorithm 2 takes into account staleness of models used to make contributions.

Simulation/convergence studies for the Modified National Institute of Standards and Technology (MNIST) are discussed. Convergence studies can help set configuration policies. For example, studies indicate that attempting to obtain contributions from at least half of the recruited clients (p=0.5) and making sure that at least half of the clients have contributed with the most recent model prior to generating a new model through aggregation, which leads to a stationary value of q=0.5 helps with better convergence. The convergence studies also show that even with very low values of p and q, a test accuracy increase is seen and when p and q are both bigger than 0.2, and acceptable convergence curves with relatively low jitter result.

Simulation/convergence studies related to the Shakespeare dataset via tensor flow federated learning are now discussed. Convergence studies can help set configuration policies. For example, the studies indicate that attempting to obtain contributions from at least half of the recruited clients (p=0.5) and making sure that at least half of the clients have contributed with the most recent model prior to generating a new model through aggregation leads to a stationary value of q=0.5. This increases convergence. The convergence studies also show that even with very low values of p and q, a test accuracy increase results and when p and q are both bigger than 0.2, and acceptable convergence curves with relatively low jitter result.

Policies are now discussed. A monitoring system and policy engine 117 outputting policies into the datacenter may be employed. Stream processors 112 in the aggregation hierarchy may produce logs for client model updates. These logs keep track of client model update contribution speed, staleness, and misses in a participant monitoring repository 119. The aggregators can produce a new global model. The policy engine 117 executes queries, alerts, and triggers and runs a control policy to generate new configurations. The policy engine 117 updates any client application configurations in the client configuration repository 116 for upcoming training cycles. The policy engine 117 also updates aggregator configurations in the aggregation configuration repository 118 for upcoming aggregation cycles.

A monitoring system and policy engine 117 outputting policies from the datacenter may also be employed. Requests for a model refresh and client configuration from a client 101 (e.g., a HTTP get request for a refresh/get model and configuration) produces system monitoring logs from the hierarchical aggregators 115 to the participant monitoring repository 119. The policy engine 117 analyzes the logs. The policy engine 117 generates any updates to the client application configurations in the client configuration repository 116 and/or any updates to the aggregator configurations in the aggregation configuration repository 118.

Example policies are now discussed. A set of policies may be advertised to encourage users to participate in federated training (e.g., with their mobile terminals). One of the reasons for designing this system of robust and adaptive aggregation is to be able to support these policies. These system designs and aggregation algorithms are adaptive to random/arbitrary user recruitment and exit and arbitrary variations in contribution cadence. Users may be barred from participation due to repeated inability to meet staleness window deadlines, which could occur for various reasons.

Model download policies are now discussed. For example, mobile terminals may attempt to download the most recent model produced by federated aggregation before a local optimization cycle when connected to the Internet, at other times (with a minimum period for each attempt specified in client configuration), when bandwidth is available, and/or when a mobile station is connected to a specific network type (e.g., WiFi). Other policies are potentially definable by the user and made available by the system. However, this is often confusing to users and may not be made available. The aggregation algorithm and system design allows for this. To avoid distributed denial of server (DDoS) attacks, there may be an upper bound on the number of downloads a policy allows per day. This bound can be updated in client configuration updates (e.g., client application attempts to download new client configs on every attempt to download the most recent model.) Model downloads first check whether an updated model is available before attempting download. This may be done through a check model update available message.

Local model optimization policies are now discussed. A client application attempts to optimize the most recent model available to the user's mobile terminal (e.g., the most recent downloaded) utilizing the user's private data under the following circumstances. An optimization cycle may be run while a terminal (e.g., cell phone) is charging during the night. An optimization cycle may be run when the terminal is fully charged and there are no other applications running after asking the user. An optimization cycle may be run based on user defined policies. However, this is often confusing to users and may not be made available. The disclosed aggregation algorithm and system design allows this.

Model parameter update contribution enqueue policies are now provided. A client application attempts to enqueue a model parameter update contribution (by posting to a URL known to client application) when bandwidth is available, there is no competition for bandwidth with other applications, and no stop signal has been received from server/data center. This also applies to policies for model download and optimization. When stop has been received, at random intervals, the client application may check or receive a resume command or an exit command in which case the application may warn the user prior to a full exit while giving a brief reason for the exit. In addition, the attempts are subject to other user defined policies. However, this is often confusing to users and may not be made available. The aggregation algorithm and system design allows this. To avoid DDoS attacks, there may be an upper bound on the number of contribution enqueue operations a policy can cause per day. This bound can be updated in client configuration updates (e.g., client application attempts to download new client configs on every attempt to download the most recent model.)

Model parameter update contribution dequeue policies are now provided. Aggregators/stream processers start dequeuing model parameter contributions after the previous aggregation cycle has finished when an adequate (pre-definable) number of contributions have been aggregated and dequeued from each of the queues or queue lengths have been reduced below a threshold, which could be zero.

Monitors and policies for avoiding DDoS on the server system (e.g., routers 111, hierarchical aggregators 115 and data stream processors 112) are provided. When one of the particular scalable queues 113 is much longer than others or when some clients 101 make too many enqueue attempts, there may be a DDoS attack. A smart attacker may perform a DDoS which affects all queues, since the messages are routed based on client application ID. When the attacker users a set of client application (and consequently IDs), there are good chances that all scalable queues 113 are affected. An imbalance in queue length may not allow for proper detection in this case. A DDoS is somewhat difficult to avoid. DDoS attacks include DDoS on system resources and DDoS on a target model. The former is more difficult to detect that the latter. The former can be avoided by proper screening at recruitment time. The latter can be avoided by monitoring the quality of contributions. The quality of contributions can be examined based on model convergence, test set, and histograms of contributions.

Due to the asynchronous and adaptive operative environment for federated learning, the system may be characterized both in terms of global test accuracy and in terms of computational cost. Global computational costs is one of the issues in federated learning that also relates to network bandwidth, storage, and energy consumption on all the edge devices (terminals). The disclosed system provides the cumulative GFLOPS in each aggregation round as the sum of GFLOPS of participating devices. pₛ=qₛ=1 is the maximum possible FLOPS required in the system. By keeping the computational cost metrics in mind, adaptive environments can employ policy algorithms that can determine a better operating point with the right trade-off between test accuracy and global computational costs.

Discovery of stable operating points in distributed and dynamic large-data systems in general and those involving statistical learning in particular can be challenging, but the type of experiments and simulations discussed in this section can be used to set some initial operating envelop boundaries for real-world datasets and models. Furthermore, using an asynchronous adaptive algorithm enables policy engines to update the operating parameters in aggregators and stream processors in order to increase effective participation and/or refresh rates. By making such adaptive adjustments the overall system performance and global computational load can be adjusted.

The disclosed system can handle asynchronous participation, random participation, random recruitment, delays and misses of participation, adaptivity in participant recruitment, and update consumption. The statistical resiliency the disclosed distributed system design is tested through a simulation environment that mimics the statistical/stochastic environment of federated learning in presence of failures, drop-outs, and other issues related to system resiliency addressed in the disclosed system design.

The disclosed system design for the present federated learning mechanism and instrumentation can be used in federated training of all machine learning models whether in deep learning or deep reinforcement learning, which can be run in training mode and/or based on updates in mobile terminals. The disclosed system has broad effect on all mobile AI models.

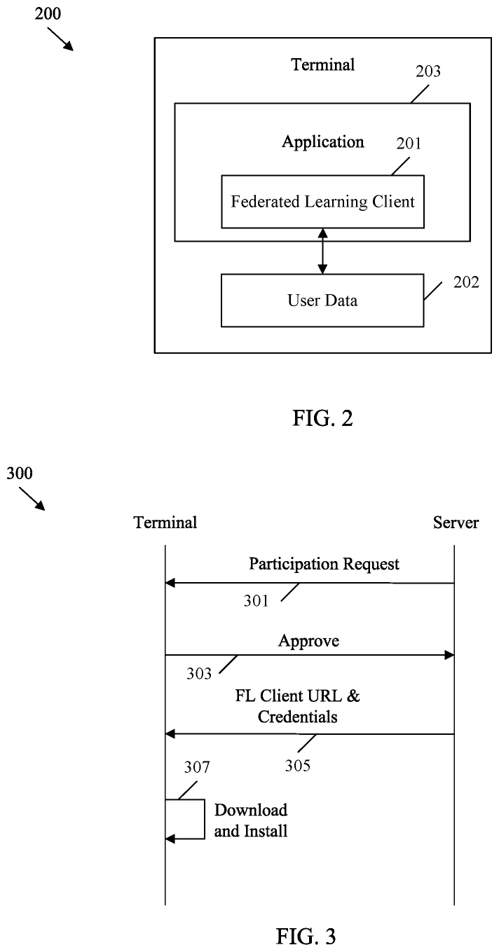

FIG. 2 is a schematic diagram of a terminal 200 configured to send model update contributions to a federated learning system. For example, a terminal 200 may be used to operate a client 101 in federated learning system 100. A terminal 200 may be any computing device capable of connecting to one or more networks. For example, a terminal may be implemented as a cell phone, smartphone, tablet, personal computer, laptop computer, or other user device. The terminal 200 stores various user data 202. The user data 202 may be any data controlled by the user that is relevant to the model. For example, the user data 202 may include the user's position and movements, the user's photos, the user's terminal usage data, the user's phone logs, the user's text logs, etc. The user data 202 is private and is not transmitted to the federated learning system to preserve the user's privacy. However, the federated learning system requests that the user assist in training the model by using the user data 202 as training data.

The terminal 200 may run one or more applications including an application 203 configured to operate in conjunction with a federated learning client 201. The federated learning client 201 may be substantially similar to client 101. In this implementation, the application 203 accesses user data 202 stored on the terminal 200 based on user permission. The federated learning client 201 performs local optimization cycles on the user data 202 related to the application 203. In another example, the federated learning client 201 may operate without an association with particular application 203. In such a case, the federated learning client 201 performs local optimization cycles on any of the user data 202, such as system level data. Notably, local training in both cases uses methods for statistical learning and optimization based on user data 202. For example, the terminal 200 may use frameworks to perform back propagation in order to compute gradients of an objective/loss function with respect to the trainable parameters of a deep neural network (DNN) and then use gradient decent to minimize the loss function. DNN local optimization can use neural processing units (NPU) or other accelerators available in the terminal 200, such as graphics processing units (GPUs) and multi-core central processing units (CPUs).

FIG. 3 is a protocol diagram of a method 300 of recruiting a terminal, such as terminal 200, to participate in a federated learning system, such as federated learning system 100. The method 300 operates between a user terminal and a server. The server may be included in the same data center as the federated learning system or the server may be a completely separate computing device. At step 301, the terminal may receive a participation request from a server. For example, the terminal may contact the server to obtain the participation request. As another example, the user can sign up to be recruited for access to the learning system. As yet another example, the user can install an application associated with federated learning on the terminal. The application can then contact the server to request access to the federated learning system.

The server can then transmit the participation request to the terminal when the federated learning system determines to recruit the user. The terminal may prompt the user for approval to participate in the federated learning system. Then the terminal may transmit an approval message to the server at step 303. At step 305, the server transmits a federated learning URL and credentials to the terminal. The URL is the location where the terminal can download the federated learning client and the credentials include any security related items that the terminal may need to access the federated learning client at the URL. At step 307, the terminal can download and install the federated learning client at the URL based on the credentials. The federated learning client can then prepare to run a local optimization cycle for corresponding model(s).

The server can assign the amount of computation tasks (e.g., client workload) for the participant, such as batch size and/or epochs to complete based on reported computation power. Such assignments can be made based on terminal capabilities to ensure lower capability clients/terminals are not assigned a task that cannot be completed due to hardware limitations. For example, some terminals may include NPUs, while other terminals include only CPU/GPUs. This can be done in the first “client config” sent to client. These actions can be performed during the download an installation process at step 307. Alternatively, these actions can be performed when the client begins a local optimization cycle as discussed below. Client configurations may be set based on benchmark results for various chips or through monitoring by the participant monitoring repository and/or the policy engine. Client configurations can be updated based on performance statistics. Clients may query client configuration updates on each refresh of new version of the aggregated model (e.g., as part of initiating a local optimization cycle). Notably, method 300 is designed to allow for incremental recruitment of participants in federated learning. Users/mobile terminals/clients can be selected, recruited, and added incrementally.

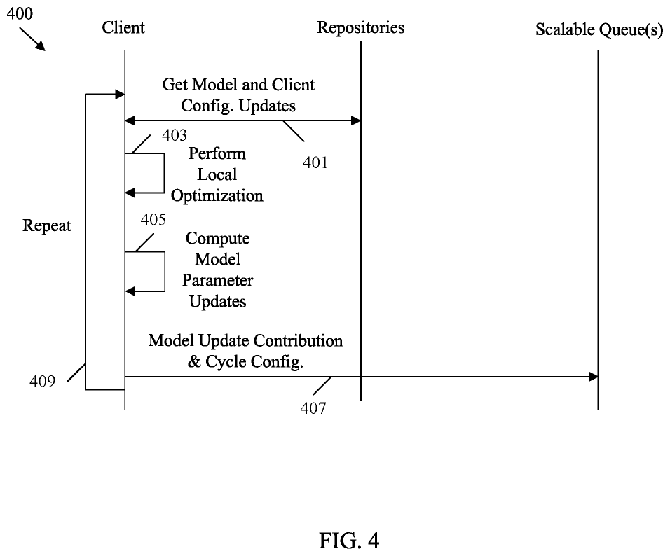

FIG. 4 is a protocol diagram of a method 400 of obtaining a model update contribution from a terminal in a federated learning system. For example, method 400 can be employed by a terminal, such as terminal 200, with a federated learning client installed according to method 300 to perform a local optimization cycle in order to transmit model update contributions to a federated learning system 100.

The method 400 operates on a client, such as client 101, that can access repositories, such as model repository 114 and client configuration repository 116, and that can transmit model update contributions toward a scalable queue, such as a scalable queue 113, via a network. At step 401, the client initiates a local optimization cycle by downloading the current version of the model and/or associated model parameters from the model repository and downloading the any client configuration updates for the client from the client configuration repository. The client configuration updates may include client configuration policies and/or client parameters. Such client configuration policies/parameters can be set a policy engine and may include parameters affecting model operations at the client including a model download policy, a model contribution policy, a resume command, a stop command, an exit command, a system signature, or combinations thereof.

The client may update stored machine learning algorithms based on the client parameters. The client can then perform local optimization at step 403 by applying user data as training data to the current version of the model using the machine learning algorithms. The client can then compute model parameters updates at step 405 based on the results of the local optimization as applied to the user data. For example, the client may determine that certain model parameters are more effective at predicting the user data than others and may suggest increasing the weighting of some model parameters while decreasing the weighting of other model parameters. It should be noted that local optimization at step 403 and model parameters update computations at step 405 may take an unknown amount of time due to variations in terminal computer resources, available storage, available power, priority policies, and/or user behavior. Some terminals perform such cycles faster than others. Further, the same terminal may perform different cycles at different speeds due to variations in user behavior and settings from one time period to the next. As such, the federated learning system operates asynchronously and does not wait on any specific client to complete method 400 before updating the model version.

At step 407, the client transmits a model update contribution toward the scalable queues. The model update contribution contains updated model parameters, but does not contain any of the user data used to obtain the updated model parameters. In this way, the user's privacy is maintained. The model update contribution may also include a client cycle configuration. The client cycle configuration may include a sequence ID of the current model downloaded at step 401 to indicate whether the model has been updated during the course of performing method 400. The client cycle configuration may also include a number of user data elements applied and/or a number of batches/epochs used to cycle through the data elements. The sequence ID can be used by the federated learning system to determine staleness, while the other client cycle configuration can be used to determine the significance of the model update contribution and the effectiveness of the client. The method 400 can then repeat at step 409 by returning to step 401.

It should be noted that the client configuration updates can be used to cause a force stop of method 400 at the client. For example, the policy engine in the federated learning system can examine monitoring logs created based on the model update contributions from the client. In the event that the client is too slow or contributing invalid, suspicious, or otherwise unhelpful results, the policy engine can set the client configuration parameters to force stop the client at the next occurrence of step 401.

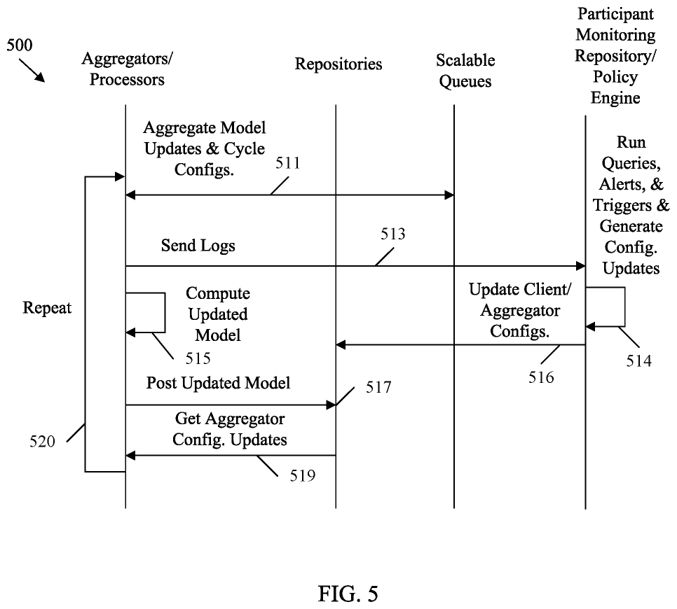

FIG. 5 is a protocol diagram of a method 500 of performing an aggregation cycle to update a model in a federated learning system based on asynchronous model update contributions from a group of clients that are uncontrolled by the system. For example, method 500 can be applied by a federated learning system 100 to aggregate model update contributions received as a result of method 400 from terminals 200 containing a federated learning client installed according to method 300.

The method of 500 is employed be a federated learning system to update a model. Accordingly, method 500 is employed on hierarchical aggregators, stream processors, various repositories, scalable queues, and a policy engine. At step 511, the hierarchical aggregators and stream processors operate to dequeue and aggregate a statistically significant number of model update contributions and client cycle configurations from the scalable queues as published by a large number of federated learning clients. For example, step 511 may be initiated based on parameters in an aggregation repository. For example, the aggregation parameters can indicate a threshold number of model update contributions or other starting conditions to trigger step 511. In this way, the aggregation cycle only operates when statistically significant data is available, but operates asynchronously and does not wait on any particular client.

At step 513, the hierarchical aggregators and stream processors generate and send monitoring logs to a participant monitoring repository. Such monitoring logs are generated based on the client cycle configuration data received from clients as part of the model update contributions. Accordingly, the monitoring logs indicate participant quality. The policy engine can then review the contents of the participant monitoring repository. For example, the policy engine can run queries on the participant monitoring repository based on alerts and/or predetermined triggers at step 514. The policy engine can then generate configuration updates such as policies and/or parameters based on the results of such queries. At step 516, the policy engine can then transmit updated client and/or aggregator configurations to the client configuration repository and/or the aggregation configuration repository, respectively. In this way the operations of the clients and the hierarchical aggregators/stream processors can be controlled based on the results of the monitoring logs. For example, clients that are performing poorly can be reconfigured to perform fewer operations, perform operations different, or removed from the system. Further, the hierarchical aggregators/stream processors can be reconfigured at runtime to alter the frequency and manner of operation of aggregation cycles.

It should be noted that steps 514 and 516 operate asynchronously from other operations. Accordingly, the hierarchical aggregators/stream processors do not await a response after sending the monitoring logs at step 513. Instead, the hierarchical aggregators/stream processors proceed to step 515 and compute an updated model based on the aggregated model update contributions from the clients. The hierarchical aggregators/stream processors can then post the updated model to the model repository at step 517. In this way, clients receive whichever version of the model that is available at the start of the client's local optimization cycle.

At step 519, the hierarchical aggregators/stream processors obtain any aggregator configuration updates from the aggregation configuration repository. As noted above, the configuration update of step 516 operates asynchronously. As such, the hierarchical aggregators/stream processors receive any updates that have been received at the aggregation configuration repository prior to step 519. In the event that such configuration updates have not been received at the aggregation configuration repository, the hierarchical aggregators/stream processors obtain such updates at the next cycle. After step 519, the process repeats at step 520 and returns to step 511 to wait for a corresponding trigger/threshold.

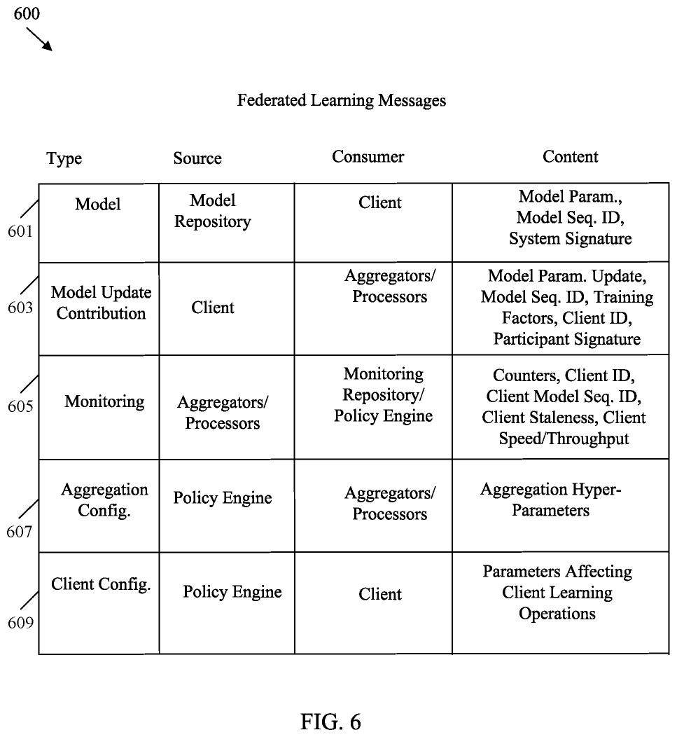

FIG. 6 illustrates example federated learning messages 600 that can be employed to operate a federated learning system, such as federated learning system 100. The federated learning messages 600 can be used inside the federated learning system 100 as well as between a terminal 200 and the federated learning system 100. The federated learning messages 600 can also be used to implement methods 300, 400, and/or 500.

The federated learning messages 600 are example messages that can provide data between federated leaning system components in order to support the federated machine learning functionality described herein. The federated learning messages 600 may include a model message 601, a model update contribution message 603, a monitoring message 605, an aggregation configuration message 607, and/or a client configuration message 609.

For example, the model message 601 may be employed to transmit a model and/or updated model parameters between a model repository and a client at step 401 of method 400. Depending on the example, the model message 601 can be referred to as being received by the client, the terminal, the user, the participant, etc. The model message 601 may include model parameters for the current version of the model, a model sequence ID of the current version of the model, and a system signature to secure the communication and confirm the model message 601 is from the federated learning system and not a malicious third party. Such model parameters are produced by the hierarchical aggregators/stream processors and stored in the model repository for use in the model message 601.

The model update contribution message 603 may be employed to transmit model update contributions from the client (e.g., terminal, participant, user, etc.) back to the hierarchical aggregators/stream processors via the scalable queues according to step 407 of method 400. The model update contribution message 603 contains suggested model parameter updates, a model sequence ID of the version of the model used by the client in the local optimization cycle, training factors used by the client, a client ID of the client, client cycle configuration data, and/or a participant signature to secure the communication and confirm the model update contribution message 603 is from the corresponding client and not a malicious third party.

The monitoring message 605 may be employed to transmit monitoring logs from the hierarchical aggregators/stream processors to the policy engine via the monitoring repository according to step 513 of method 500. The monitoring message 605 contains data indicating participant quality for the clients. For example, a monitoring message 605 may contain client counters, a client ID, a client model sequence ID of the version of the model used by the client at the corresponding local optimization cycle, a client staleness data indicating how stale the clients model update contributions are by difference in model version, client speed data, and/or client throughput data. The policy engine can use such data to determine how the system is working as a whole as well as how the system is working relative to particular clients. The policy engine can then change configurations accordingly.

The aggregation configuration message 607 may be employed by the policy engine to alter configurations for the hierarchical aggregators/stream processors. For example, the aggregation configuration message 607 can be sent from the policy engine to the aggregation configuration repository according to step 516 of method 500 to be downloaded by the hierarchical aggregators at the start of the next aggregation cycle. For example, an aggregation configuration message 607 may contain aggregation hyper-parameters such as window sizes, discount rates related to staleness, and/or other model update related parameters.

The client configuration message 609 may be employed by the policy engine to alter configurations for the clients. For example, the client configuration message 609 can be sent from the policy engine to the client configuration repository according to step 516 of method 500. The resulting parameters can then be downloaded by the client according to step 401 of method 400 at the start of the next local optimization cycle for the corresponding client. For example, the client configuration message 609 may contain parameters affecting client learning operations, such as model download and enqueue contribution policies, resume commands, stop commands, exit command, and/or a system signature to secure the communication and confirm the client configuration message 609 is from the federated learning system and not a malicious third party.

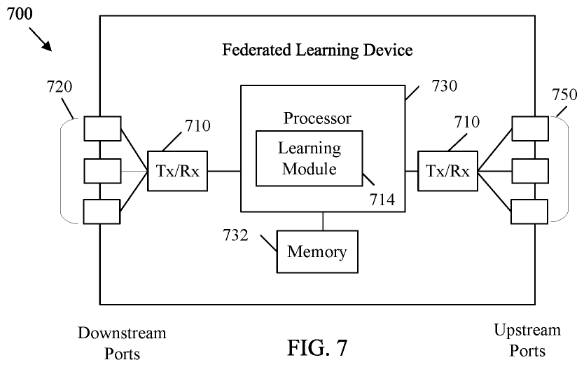

FIG. 7 is a schematic diagram of an example federated learning device 700 for use in a federated learning system, such as federated learning system 100. For example, the federated learning device 700 can be employed to implement a terminal 200, a federated learning device 900, and/or any device in the federated learning system 100. Further, the federated learning device 700 may employ federated learning messages 600 and can be employed to implement methods 300, 400, 500, and/or 800. Hence, the federated learning device 700 is suitable for implementing the disclosed examples/embodiments as described herein. The federated learning device 700 comprises downstream ports 720, upstream ports 750, and/or one or more transceiver units (Tx/Rx) 710, including transmitters and/or receivers for communicating data upstream and/or downstream over a network. The federated learning device 700 also includes a processor 730 including a logic unit and/or central processing unit (CPU) to process the data and a memory 732 for storing the data. The federated learning device 700 may also comprise optical-to-electrical (OE) components, electrical-to-optical (EO) components, and/or wireless communication components coupled to the upstream ports 750 and/or downstream ports 720 for communication of data via electrical, optical, and/or wireless communication networks.

The processor 730 is implemented by hardware and software. The processor 730 may be implemented as one or more CPU chips, cores (e.g., as a multi-core processor), field-programmable gate arrays (FPGAs), application specific integrated circuits (ASICs), digital signal processors (DSPs), or any combination of the foregoing. The processor 730 is in communication with the downstream ports 720, Tx/Rx 710, upstream ports 750, and memory 732. The processor 730 comprises a learning module 714. The learning module 714 may implement one or more of the disclosed embodiments described herein. Specifically, the learning module 714 may be employed as a policy engine to asynchronously review monitoring logs and alter configurations to control clients, hierarchical aggregators, and/or stream processors.

In another example, the learning module 714 can be employed to implement hierarchical aggregators/stream processors to asynchronously update a model based on model update contributes from a large group of uncontrolled clients. In yet another example, the learning module 714 can act as one or more of the repositories described herein to support asynchronous and dynamic reconfiguration of federated learning components. Accordingly, the learning module 714 may be configured to perform mechanisms to address one or more of the problems discussed above. As such, the learning module 714 improves the functionality of the federated learning device 700 as well as addresses problems that are specific to the machine learning/artificial intelligence arts. Further, the learning module 714 effects a transformation of the federated learning device 700 to a different state. Alternatively, the learning module 714 can be implemented as instructions stored in the memory 732 and executed by the processor 730 (e.g., as a computer program product stored on a non-transitory medium).

The memory 732 comprises one or more memory types such as disks, tape drives, solid-state drives, read only memory (ROM), random access memory (RAM), flash memory, ternary content-addressable memory (TCAM), static random-access memory (SRAM), and other optical and/or electrical memory systems suitable for this task. The memory 732 may be used as an over-flow data storage device, to store programs when such programs are selected for execution, and to store instructions and data that are read during program execution.

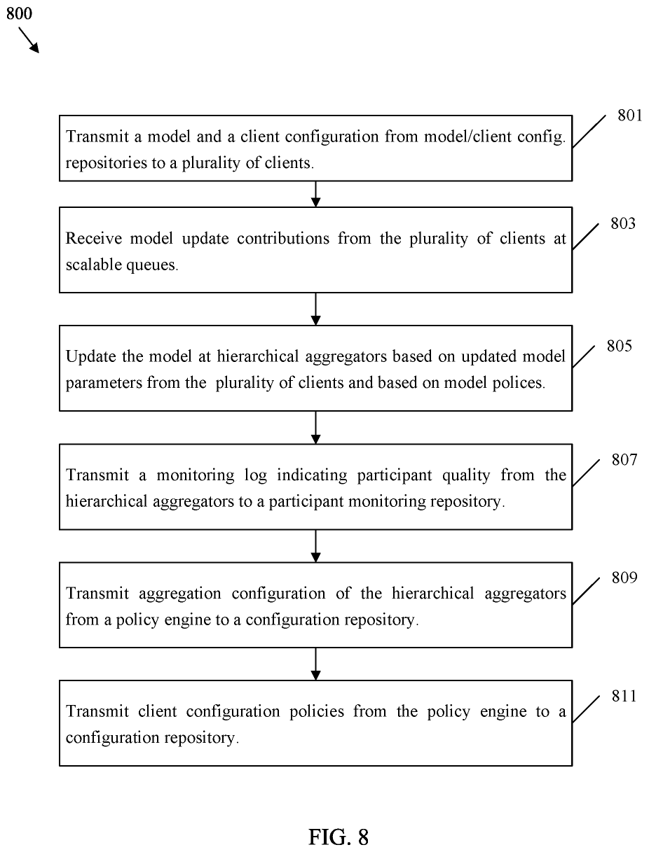

FIG. 8 is a flowchart of an example method 800 of operating a federated learning system, such as federated learning system 100. Method 800 is an example implementation of methods 300, 400, 500, and/or 800. As such, method 800 may interact with and/or be implemented by a terminal 200, a federated learning device 700, and/or a federated learning device 900. Accordingly, method 800 may employ federated learning messages 600.

At step 801, a model from a model repository is communicated/transmitted to a plurality of clients. The model may be communicated using a pull methodology, and hence the clients may pull down the model from the model repository at the start of each client's respective local optimization cycle. Communicating the model may include forwarding to the plurality of clients model parameters, a model sequence identifier for a version of the model, a system signature, or combinations thereof. A client configuration repository may also transmit client configuration policies and/or parameters to the clients at step 801. The client configuration policies may include parameters affecting model operations at the plurality of clients including a model download policy, a model contribution policy, a resume command, a stop command, an exit command, a system signature, or combinations thereof. The clients can then perform local optimization cycles based on the model and each client's respective client configuration policies/parameters.

At step 803, model update contributions from the plurality of clients are received by a plurality of queues. The model update contributions contain updated model parameters and client cycle configuration data, but not user data. The updated model parameters indicate suggested model updates, such as model parameter weighting changes, determined by applying private user data to the model as training data. For example, the model update contributions may include a model sequence identifier for a version of the model associated with the updated model parameters, training factors used by the corresponding client, a client identifier associated with the corresponding client, a participant signature, or combinations thereof. The client cycle configuration data describes the quantity and/or quality of the participation of each client during that client's last local optimization cycle. As each client may begin step 801 at different times and may take varying amounts of time to complete a local optimization cycle, steps 801 and 803 are performed asynchronously from each other as well as from other steps in method 800.

At step 805, hierarchical aggregators and/or stream processors can update the model based on the updated model parameters from the plurality of clients via the scalable queues. The aggregation and model update can be performed based on model polices including an update threshold indicating an amount of received responses from the plurality of clients to initiate an update of the model. Further, step 805 may be performed based on aggregation hyper-parameters including window sizes, discount rates, or combinations thereof. The model policies and/or aggregation hyper-parameters may be obtained from an aggregation configuration repository.

At step 807, the hierarchical aggregators and/or stream processors can transmit monitoring logs indicating participant quality to a participant monitoring repository. The monitoring logs can be generated based on the client cycle configuration data received from the clients at the scalable queues as part of the model update contributions. The monitoring log may include a counter, a client identifier, include a model sequence identifier, client staleness data, client speed data, client throughput data, or combinations thereof. As described above, steps 805 and 807 may operate asynchronously from other steps in method 800.

At step 809, a policy engine may review data from the monitoring logs in the participant monitoring repository. The policy engine may then make changes to the operations of the clients and/or the hierarchical aggregators/stream processors. For example, the policy engine can transmit an aggregation configuration of the hierarchical aggregators to a configuration repository at step 809 in order to control functionality at step 805. The aggregation configuration may include model policies and/or aggregation hyper-parameters including window sizes, discount rates, or combinations thereof. Further, the policy engine may transmit client configuration policies/parameters to a configuration repository. Such client configuration policies control the operation of the clients when performing local optimization cycles in response to step 801. As such, method 800 offers a mechanism for a large and scalable number of federated clients to asynchronously perform federated learning and provide model update contribution in a secure manner for processing by a robust, resilient, and adaptive federated learning system.

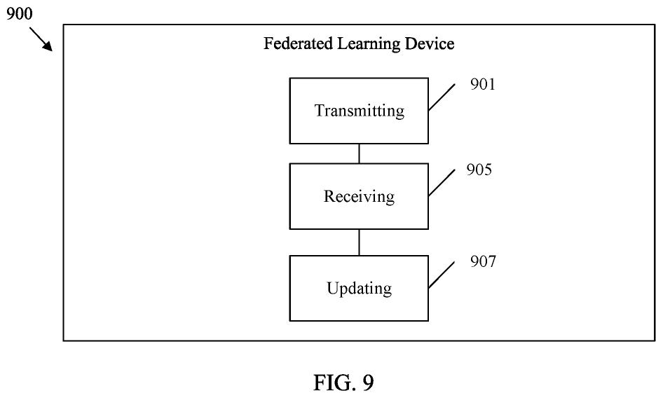

FIG. 9 is a schematic diagram of another example federated learning device 900 for use in a federated learning system, such as federated learning system 100. For example, the federated learning device 900 may operate in conjunction with terminal 200 and/or federated learning device 700 and may employ federated learning messages 600 as part of methods 300, 400, 500, and/or 800. The federated learning device 900 comprises a transmitting module 901 for transmitting a model to a plurality of clients. The federated learning device 900 also comprises a receiving module 905 for receiving model update contributions from the plurality of clients, the model update contributions containing updated model parameters. The federated learning device 900 also comprises an updating module 907 for updating the model based on the updated model parameters from the plurality of clients and based on model polices including an update threshold indicating an amount of received responses from the plurality of clients to initiate an update of the model.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A federated learning system comprising:
scalable queues coupled to receive model update contributions from a plurality of clients, the model update contributions containing updated model parameters;
a model repository coupled to receive and store, from a terminal, a model for access by the plurality of clients;
a configuration repository coupled to receive and store model polices including an update threshold, the update threshold indicating how many responses need to be received from the plurality of clients to initiate an update of the model; and
hierarchical aggregators configured to:
generate a model update based on the updated model parameters received from the plurality of clients and based on the update threshold; and
output the model update to the model repository.

2. The federated learning system of claim 1, wherein the configuration repository is further coupled to receive and store client configuration policies including client parameters affecting model operations at the plurality of clients.

3. The federated learning system of claim 2, wherein the client parameters direct model download operations and the model update contributions at the plurality of clients.

4. The federated learning system of claim 2, wherein the client parameters direct model analysis resume, model analysis stop, and model analysis exit at the plurality of clients.

5. The federated learning system of claim 2, wherein the client parameters direct local optimization at the plurality of clients.

6. The federated learning system of claim 1, wherein the model polices further include staleness policies.

7. The federated learning system of claim 1, further comprising a policy engine configured to set the model policies and client configuration policies.

8. The federated learning system of claim 7, wherein the policy engine is further configured to configure the hierarchical aggregators with hyper-parameters to scale aggregation weights.

9. The federated learning system of claim 7, further comprising a participant monitoring repository coupled to:
receive monitoring logs indicating participant quality for the plurality of clients; and
transmit the monitoring logs to the policy engine to support setting the model policies and the client configuration policies.

10. The federated learning system of claim 9, wherein the hierarchical aggregators are configured to transmit the monitoring logs to the participant monitoring repository.

11. The federated learning system of claim 1, wherein the scalable queues receive the model update contributions from the plurality of clients according to a hash function.

12. The federated learning system of claim 1, wherein the hierarchical aggregators are further configured to dequeue and aggregate the model update contributions from the scalable queues.

13. A method of configuring a federated learning system, the method comprising:
transferring a model to a plurality of clients from a model repository;
receiving, by scalable queues, model update contributions from the plurality of clients, the model update contributions containing updated model parameters; and
updating, by hierarchical aggregators, the model based on the updated model parameters from the plurality of clients and based on model polices including an update threshold indicating how many responses need to be received from the plurality of clients to initiate an update of the model.

14. The method of claim 13, wherein the model includes model parameters, a model sequence identifier for a version of the model, a system signature, or combinations thereof.

15. The method of claim 13, wherein the model update contributions include a model sequence identifier for a version of the model associated with the updated model parameters, training factors of a corresponding client, a client identifier associated with the corresponding client, a participant signature, or combinations thereof.

16. The method of claim 13, further comprising transmitting, by the hierarchical aggregators, a monitoring log indicating participant quality to a participant monitoring repository, wherein the monitoring log includes a counter, a client identifier, a model sequence identifier, client staleness data, client speed data, client throughput data, or combinations thereof.

17. The method of claim 13, further comprising transmitting, by a policy engine, aggregation configuration of the hierarchical aggregators to a configuration repository, wherein the aggregation configuration includes aggregation hyper-parameters including window sizes, discount rates, or combinations thereof.

18. The method of claim 13, further comprising transmitting, by a policy engine, client configuration policies to a configuration repository, wherein the client configuration policies include parameters affecting model operations at the plurality of clients including a model download policy, a model contribution policy, a resume command, a stop command, an exit command, a system signature, or combinations thereof.

19. A federated learning system comprising:
a receiver operably coupled to receive model update contributions of a model from a plurality of clients, the model update contributions containing updated model parameters; and
a processor operably coupled to the receiver, the processor configured to update the model based on the updated model parameters from the plurality of clients and based on model polices including an update threshold indicating how many responses need to be received from the plurality of clients to initiate an update of the model.

20. The federated learning system of claim 19, wherein the model includes model parameters, a model sequence identifier for a version of the model, a system signature, or combinations thereof.
